(19) United States
(12) Patent Application Publication
(10) Pub. No.: US 2021/0001742 A1
(43) Pub. Date: Jan. 7, 2021

(54) CHARGING DEVICE AND CONTROL METHOD THEREOF

(71) Applicants: HYUNDAI MOTOR COMPANY, Seoul (KR); KIA MOTORS CORPORATION, Seoul (KR)

(72) Inventors: Jaehyuk CHOI, Seoul (KR); Hyunsup KIM, Gwangmyeong-si (KR); Jae Young JEUN, Yongin-si (KR); Byeong Seob SONG, Yongin-si (KR)

(73) Assignees: HYUNDAI MOTOR COMPANY, SEOUL (KR); KIA MOTORS CORPORATION, SEOUL (KR)

(21) Appl. No.: 16/680,170

(22) Filed: Nov. 11, 2019

(30) Foreign Application Priority Data
Jul. 4, 2019 (KR) 10-2019-0080616

(51) Int. Cl. B60L 53/62; H02J 7/35; H02J 7/02; B60L 53/53; B60L 53/51; B60L 53/31; B60L 53/66; B60L 53/22; B60L 50/60; B60L 53/18; B60L 53/16

(52) U.S. Cl. CPC B60L 53/62; H02J 7/355; H02J 7/022; B60L 53/53; B60L 53/51; B60L 53/16; B60L 53/66; B60L 53/22; B60L 50/66; B60L 53/18; B60L 53/31

(57) ABSTRACT

A charging device and a control method are provided. The charging device may include: a battery; a solar panel; a socket electrically connected to a power system; a first connector electrically connected to the vehicle; a transceiver configured to communicate with the power system and the vehicle; a power supply circuit electrically connected to the battery, the solar panel, the socket and the first connector; and a controller configured to control the power supply circuit to supply power that is supplied from at least one of the battery or the solar panel to at least one of the power system or the vehicle when a request for power is received from the power system and the vehicle.

### CROSS-REFERENCE TO RELATED APPLICATION

The present application claims priority to and the benefit of Korean Patent Application No. 10-2019-0080616, filed on Jul. 4, 2019, which is incorporated herein by reference in its entirety.

### TECHNICAL FIELD

The present disclosure relates to a charging device for supplying power to an electric vehicle and a control method thereof.

### BACKGROUND

The statements in this section merely provide background information related to the present disclosure and may not constitute prior art.

Typically, vehicles use gasoline or diesel as fuel. Gasoline and diesel generate harmful substances and cause air pollution. Due to the depletion of crude oil, each industry is in a hurry to develop alternative energy, and as an alternative, electric vehicles are being developed and operated.

However, in the case of electric vehicles, the time required for charging is longer than that of gasoline and diesel vehicles, which causes trouble in operation, and the charging infrastructure is also insufficient, which makes it difficult to commercialize electric vehicles.

In addition, as the demand for electric vehicles increases, the demand for power is expected to explode. Therefore, an energy supply and demand strategy that can meet the demand for power is required for the commercialization of electric vehicles.

### SUMMARY

The present disclosure provides a charging device capable of moving to a location where a vehicle requesting charging is located and capable of providing power to a power system in addition to the vehicle, and a control method thereof.

In one aspect of the present disclosure, a charging device includes: a battery; a solar panel; a socket electrically connected to a power system; a first connector electrically connected to the vehicle; a transceiver to communicate with the power system and the vehicle; a power supply circuit electrically connected to the battery, the solar panel, the socket and the first connector; and a controller configured to control the power supply circuit to supply power supplied from at least one of the battery or the solar panel to at least one of the power system or the vehicle according to whether a request for power from the power system and the vehicle has been received.

The controller is configured to control the power supply circuit to supply power supplied from at least one of the battery or the solar panel to both the power system and the vehicle when the request for power is received from the power system and the vehicle.

The controller is configured to control the power supply circuit to maintain a sum of a current of power supplied to the power system and a current of power supplied to the vehicle at a predetermined value.

When the power supply to the vehicle is completed and there is no current supplied to the vehicle after controlling the power supply circuit to supply power to both the power system and the vehicle, the controller is configured to control the power supply circuit to supply power to the power system or transfer power obtained from the power system and the solar panel to the battery based on a comparison between the power produced in the power system and the power demanded through the power system.

The power supply circuit includes: an AC/DC converter electrically connected to the socket; a first DC/DC converter electrically connected to the solar panel; and a second DC/DC converter electrically connected to the first connector.

The charging device further includes: a second connector electrically connected to the AC/DC converter and electrically connected to the vehicle, when receiving a request for power from vehicles connected to each of the first connector and the second connector and there is no request for power from the power system, the controller is configured to control the power supply circuit to supply power supplied from at least one of the battery or the solar panel to vehicles connected to each of the first connector and the second connector.

The controller is configured to supply a maximum output current to any one of the vehicles connected to each of the first connector and the second connector, reduce the current supplied to any one of the vehicle according to time after the end of the charge by the maximum output current, and control the power supply circuit to supply an increasing current in correspondence with a decreasing amount of current supplied to the any one vehicle to the other one of the vehicles connected to each of the first connector and the second connector.

The first connector supplies a DC power boosted by the second DC/DC converter to the vehicle, and the second connector supplies DC power or AC power to the vehicle

The DC power supplied to the vehicle from the second connector is boosted by the motor-inverter in the vehicle and supplied to the battery in the vehicle.

The controller is configured to compare the power produced by the power system with the power demanded through the power system when a request for power from the power system and the vehicle is not received, and control the power supply circuit to supply power obtained from at least one of the power system or the solar panel to the battery when the power produced by the power system is greater than the power demanded through the power system.

The controller is configured to control the power supply circuit to supply power supplied from at least one of the battery or the solar panel to the power system when the power produced by the power system is smaller than the power demanded through the power system.

The controller is configured to control the power supply circuit to supply power supplied from at least one of the battery or the solar panel to the vehicle when receiving a request for power only from the vehicle.

In another aspect of the present disclosure, a control method of charging device including a battery, a solar panel, a socket electrically connected to a power system, a first connector electrically connected to the vehicle, a transceiver to communicate with the power system and the vehicle and a power supply circuit electrically connected to the battery, the solar panel, the socket and the first connector, includes: controlling the power supply circuit to supply power supplied from at least one of the battery or the solar panel to at least one of the power system or the vehicle according to whether a request for power from the power system and the vehicle has been received.

The controlling the power supply circuit includes: controlling the power supply circuit to supply power supplied from at least one of the battery or the solar panel to both the power system and the vehicle when the request for power is received from the power system and the vehicle.

The controlling the power supply circuit includes: controlling the power supply circuit to maintain a sum of a current of power supplied to the power system and a current of power supplied to the vehicle at a predetermined value.

The controlling the power supply circuit includes: when the power supply to the vehicle is completed and there is no current supplied to the vehicle after controlling the power supply circuit to supply power to both the power system and the vehicle, controlling the power supply circuit to supply power to the power system or transfer power obtained from the power system and the solar panel to the battery based on a comparison between the power produced in the power system and the power demanded through the power system.

The power supply circuit includes: an AC/DC converter electrically connected to the socket; a first DC/DC converter electrically connected to the solar panel; and a second DC/DC converter electrically connected to the first connector.

The charging device further includes: a second connector electrically connected to the AC/DC converter and electrically connected to the vehicle, the controlling the power supply circuit includes: when receiving a request for power from vehicles connected to each of the first connector and the second connector and there is no request for power from the power system, controlling the power supply circuit to supply power supplied from at least one of the battery or the solar panel to vehicles connected to each of the first connector and the second connector.

The controlling the power supply circuit includes: supplying a maximum output current to any one of the vehicles connected to each of the first connector and the second connector; reducing the current supplied to the any one of the vehicle according to time after the end of the charge by the maximum output current; and controlling the power supply circuit to supply an increasing current in correspondence with a decreasing amount of current supplied to the any one vehicle to the other one of the vehicles connected to each of the first connector and the second connector.

The first connector supplies a DC power boosted by the second DC/DC converter to the vehicle, and wherein the second connector supplies DC power or AC power to the vehicle.

The DC power supplied to the vehicle from the second connector is boosted by the motor-inverter in the vehicle and supplied to the battery in the vehicle.

The controlling the power supply circuit includes: comparing the power produced by the power system with the power demanded through the power system when a request for power from the power system and the vehicle is not received; and controlling the power supply circuit to supply power obtained from at least one of the power system or the solar panel to the battery when the power produced by the power system is greater than the power demanded through the power system.

The controlling the power supply circuit includes: controlling the power supply circuit to supply power supplied from at least one of the battery or the solar panel to the power system when the power produced by the power system is smaller than the power demanded through the power system.

The controlling the power supply circuit includes: controlling the power supply circuit to supply power supplied from at least one of the battery or the solar panel to the vehicle when receiving a request for power only from the vehicle.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a diagram illustrating an appearance of a charging device in one form of the present disclosure.

FIG. 2 is a control block diagram of a charging device in one form of the present disclosure.

FIG. 3 is a diagram schematically illustrating a power supply circuit of a charging device in one form of the present disclosure.

FIG. 4 is a diagram illustrating a case in which a charging device charges a battery in one form of the present disclosure.

FIG. 5 is a diagram illustrating a case in which a charging device supplies power to a power system in one form of the present disclosure.

FIG. 6 is a diagram illustrating a case in which a charging device supplies power to a vehicle in one form of the present disclosure.

FIG. 7 is a diagram illustrating a case in which a charging device supplies power to both a power system and a vehicle in one form of the present disclosure.

FIG. 8 is a diagram illustrating an output current when a charging device supplies power to both a power system and a vehicle in one form of the present disclosure.

FIG. 9 is a diagram illustrating a case in which a charging device supplies power to a plurality of vehicles in one form of the present disclosure.

FIG. 10 is a diagram illustrating an output current when a charging device supplies power to a plurality of vehicles in one form of the present disclosure.

FIG. 11 is a flowchart illustrating a case of determining an operation mode of a control method of a charging device in one form of the present disclosure.

FIG. 12 is a flowchart illustrating a case where a request for power is received from both a power system and a vehicle in a control method of a charging device in one form of the present disclosure.

FIG. 13 is a flowchart illustrating a case where a request for power is received from a plurality of vehicles in a control method of a charging device in one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

It will be understood that when an element is referred to as being “connected” to another element, it can be directly or indirectly connected to the other element, wherein the indirect connection includes “connection” via a wireless communication network.

Also, when a part “includes” or “comprises” an element, unless there is a particular description contrary thereto, the part may further include other elements, not excluding the other elements.

As used herein, the singular forms “a,” “an” and “the” are intended to include the plural forms as well, unless the context clearly indicates otherwise.

As used herein, the terms “portion,” “unit,” “block,” “member,” and “module” refer to a unit that can perform at least one function or operation. For example, these terms may refer to at least one process which is performed by at least one piece of hardware such as a field-programmable gate array (FPGA) and an application specific integrated circuit (ASIC), and at least one piece of software stored in a memory or a processor.

An identification code is used for the convenience of the description but is not intended to illustrate the order of each step. Each of the steps may be implemented in an order different from the illustrated order unless the context clearly indicates otherwise.

Hereinafter, a charging apparatus and a control method thereof in some forms of the present disclosure will be described in detail with reference to the accompanying drawings.

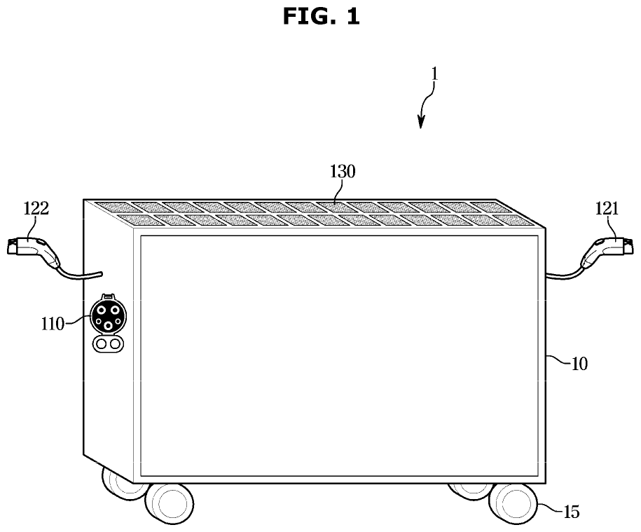

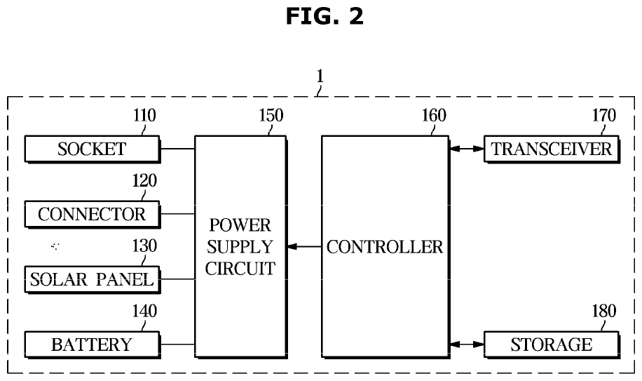

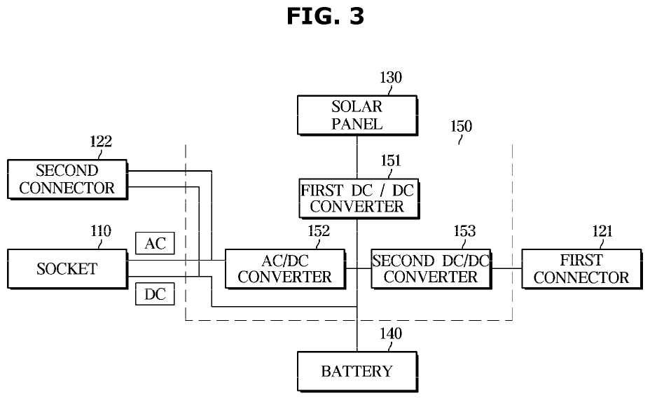

FIG. 1 is a diagram illustrating an appearance of a charging device in some forms of the present disclosure. FIG. 2 is a control block diagram of a charging device according to an exemplary form. FIG. 3 is a diagram schematically illustrating a power supply circuit of a charging device in some forms of the present disclosure.

Referring to FIG. 1, the charging device 1 in some forms of the present disclosure may include a main body 10 and a plurality of wheels 15 provided at a lower end of the main body 10 for mobility.

The main body 10 includes a socket 110 electrically connected to a power system, a plurality of connectors 121 and 122 electrically connected to a vehicle, and a solar panel 130 generating power using sunlight.

Socket 110 and a plurality of connectors (121, 122; 120), as shown in FIG. 1, may be provided on one side of the main body 10, the position and number provided are not limited to FIG. 1. It can be prepared in various ways according to the intention of the designer.

In addition, the solar panel 130 may be provided on the upper end of the body 10 to receive sunlight.

The main body 10 may be provided in a box shape, as shown in FIG. 1, and may be provided in various forms (for example, circular, elliptical, triangular prism, etc.).

The plurality of wheels 15 may be driven by a motor (not shown) provided in the main body 10, and may be steered by a steering device (not shown) provided in the main body 10. In this case, the charging device 1 in some forms of the present disclosure may control a motor (not shown), a steering device (not shown), etc. to move to a vehicle requesting charging by using an autonomous driving function. In some forms of the present disclosure, the charging device 1 may further include a robot device (not shown) to automatically insert the connector 120 into the socket of the vehicle requesting charging to provide power to the vehicle.

In some forms of the present disclosure, the charging device 1 may not be provided with a plurality of wheels 15, but may be provided at a specific location (eg, at home or a yard). In this case, in some forms of the present disclosure, the solar panel 130 may be provided in a separate space (for example, a roof) instead of the main body 10.

Referring to FIG. 2, the charging device 1 in some forms of the present disclosure includes a battery 140 capable of charging and discharging power in addition to the socket 110, the connector 120, and the solar panel 130 described above, a power supply circuit 150 electrically connected to the socket 110, the connector 120, the solar panel 130, and the battery 140 to control charge and discharge of the power, a controller 160 for controlling the power supply circuit 150 for charging and discharging power to the power system or the vehicle in response to a request for power from the power system and the vehicle, a transceiver 170 for communicating with the power system and the vehicle and storage 180 for storing a variety of information necessary for the control of the charging device 1.

The socket 110 in some forms of the present disclosure may be electrically connected to the power system to supply power to the power system or to receive power from the power system.

The socket 110 may correspond to a form corresponding to any one connector of an AC single phase 5 pin, an AC three phase 7 pin, a DC CHAdeMO 10 pin, or a DC combo 7 pin. However, the socket 110 is not limited to the above example, and may be employed without limitation as long as it is in the form of a socket provided for power supply.

The connector 120 in some forms of the present disclosure may be provided with any one of an AC single phase 5 pin, an AC three phase 7 pin, a DC CHAdeMO 10 pin, or a DC combo 7 pin. However, the connector 120 is not limited to the above example, and may be employed without limitation as long as it is in the form of a connector provided for power supply.

In addition, the connector 120 may be provided in plurality in some forms of the present disclosure, and may simultaneously supply power to a plurality of vehicles. Hereinafter, an example in which two connectors 121 and 122 are provided will be described, but the number of connectors 120 is not limited thereto. The charging device 1 may include two or more connectors 120 on the assumption that a circuit configuration (for example, a converter, etc.) connected to the connector 120 is provided.

The solar panel 130 in some forms of the present disclosure is a configuration in which a power generation method of converting sunlight directly into power (direct current) by a solar cell is applied. The solar cell may be formed to convert light energy into electrical energy.

The solar cell is composed of a P-type semiconductor and an N-type semiconductor, and when light shines, electric charges move to generate a potential difference. Since the solar cell is mounted on the top of the main body 10, it is possible to produce electrical energy using natural light supplied from the sun. That is, the solar panel 130 is composed of a solar cell and can produce power based on solar energy.

The battery 140 in some forms of the present disclosure may be provided inside the main body 10 and may store power. That is, the battery 140 may supply power or store power in accordance with the operation of the power supply circuit 150.

To this end, the battery 140 may correspond to any one of a lithium ion battery and a lithium ion polymer battery. However, the type of battery 140 is not limited to the above example, and may be employed without limitation as long as it can store power.

The power supply circuit 150 in some forms of the present disclosure may transfer power supplied from the power system or the solar panel 130 to the battery 140 under the control of the controller 160, and may supply power supplied from the battery 140 to a power system or a vehicle.

To this end, the power supply circuit 150 may include an AC/DC converter for converting AC power to DC power, a DC/DC converter for converting the magnitude of the DC power, and various switches for controlling the flow of current.

For example, as shown in FIG. 3, the power supply circuit 150 may include a first DC/DC converter 151 electrically connected to the solar panel 130 to convert the magnitude of the DC power generated from the solar panel 130, an AC/DC converter 152 electrically connected to the socket 110 to convert AC power supplied from the power system into DC power, and a second DC/DC converter 153 electrically connected to the first connector 121 to convert the magnitude of the DC power supplied from the battery 140.

As such, the power supply circuit 150 includes various converters 151, 152, and 153, so that the power supplied from the solar panel 130 or the power system can be compatible with the battery 140. And, the power supply circuit 150 makes the power supplied from the battery 140 compatible with the power system or the vehicle.

In some forms of the present disclosure, the AC/DC converter 152 may be electrically connected to a second connector 122 that may be electrically connected to the vehicle in addition to the socket 110. Through this, the AC/DC converter 152 may transfer power supplied from the battery 140 and converted into AC power to the vehicle.

In addition, the power supply circuit 150 further includes a circuit configuration capable of transmitting and receiving DC power between the socket 110 and the battery 140 according to the type of the socket 110 (eg, the DC combo 7-pin) in addition to the AC/DC converter 152 connected to the socket 110. Although not illustrated, the circuit configuration may further include a DC/DC converter.

However, the power supply circuit 150 may further include a filter for controlling noise and various switches capable of controlling the flow of current.

The controller 160, in some forms of the present disclosure, may control the power supply circuit 150 to supply power supplied from at least one of the battery or the solar panel to at least one of the power system or the vehicle based on the request for power from the power system and the vehicle.

In detail, the controller 160 may charge the battery 140 with power supplied from the power system, or supply power supplied from at least one of the solar panel 130 or the battery 140 to at least one of the power system and the vehicle based on the request for power from the power system and the vehicle. This will be described in detail later.

The controller 160 may include at least one memory in which a program for performing the above-described operation and the operation described below is stored, and at least one processor for executing the stored program. In the case of a plurality of memories and processors, they may be integrated in one chip or may be provided in physically separated locations.

The transceiver 170 in some forms of the present disclosure may receive a request for power from the power system or the vehicle by performing communication with the power system and the vehicle through wireless or wired communication.

The wireless communication may include cellular communication using at least one of 5G (5th generation), LTE, LTE Advance (LTE-A), code division multiple access (CDMA), wideband CDMA (WCDMA), universal mobile telecommunications system (UMTS), wireless broadband (WiBro) or global system for mobile communications (GSM). In some forms of the present disclosure, the wireless communication may include at least one of wireless fidelity (WiFi), Bluetooth, Bluetooth low power (BLE), Zigbee, near field communication (NFC), magnetic secure transmission, radio frequency (RF) or a body area network (BAN). However, the present disclosure is not limited to the above example, and any communication protocol capable of performing wireless communication may be used without limitation. For example, wired communication may include at least one of universal serial bus (USB), high definition multimedia interface (HDMI), RS-232 (recommended standard 232), power line communication via socket (110) or connector (120), or a plain old telephone service (POTS). However, the present disclosure is not limited to the above example, and any communication protocol capable of performing wired communication may be used without limitation.

The storage 180 in some forms of the present disclosure may store various information required for the charging device 1. For example, the storage 180 may store an algorithm for determining the charging/discharging direction of the power based on a request for power from the power system and the vehicle. And the storage 180 may store an algorithm for supplying power to a plurality of vehicles and an algorithm for supplying power to the vehicle and the power system.

The storage 180 may be implemented as at least one of a non-volatile memory device (for example, a cache, Read Only Memory (ROM), Programmable ROM (PROM), Erasable Programmable ROM (EPROM), Electrically Erasable Programmable ROM (EEPROM), and flash memory), a volatile memory device (for example, Random Access Memory (RAM)), or a storage medium (for example, Hard Disk Drive (HDD) and Compact Disc Read Only Memory (CD-ROM)) in order to store various information necessary for the control of the charging device 1. However, the present disclosure is not limited thereto, and a type capable of storing various types of information may be used as the type of the storage unit 180.

In the above, various configurations included in the charging device 1 have been described in detail. Hereinafter, a case in which the charging device 1 supplies power or receives power will be described in detail.

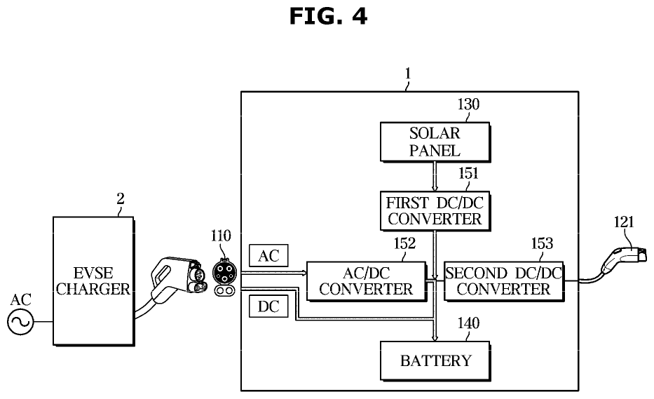

FIG. 4 is a diagram illustrating a case in which a charging device charges a battery in some forms of the present disclosure.

Referring to FIG. 4, the controller 160 in some forms of the present disclosure may compare the power produced by the power system 2 with the power demanded through the power system 2 when a request for power from the power system 2 and the vehicle 3 has not been received. The controller 160 may control the power supply circuit 150 to supply power obtained from at least one of the power system 2 or the solar panel 130 to the battery 140 when the power produced by the power system 2 is greater than the power demanded through the power system 2.

That is, the controller 160 may receive information about the maximum power and the demanded power from the power system 2 including all components up to the power plant in addition to the electric vehicle service equipment (EVSE) charger. The controller 160 may control the power supply circuit 150 to receive power through the power system 2 when the power produced by the power system 2 is greater than the power demanded through the power system 2. The controller 160 may control the power supply circuit 150 to charge the battery 140 by transferring the supplied power to the battery 140.

In this case, the charging device 1 may receive at least one of AC power or DC power from the power system 2 according to the type of the socket 110.

In addition, the controller 160 may control the power supply circuit 150 to supply power compatible with the battery 140 by converting the power produced from the solar panel 130 through the first DC/DC converter 151 when the power produced by the power system 2 is greater than the power demanded through the power system 2,

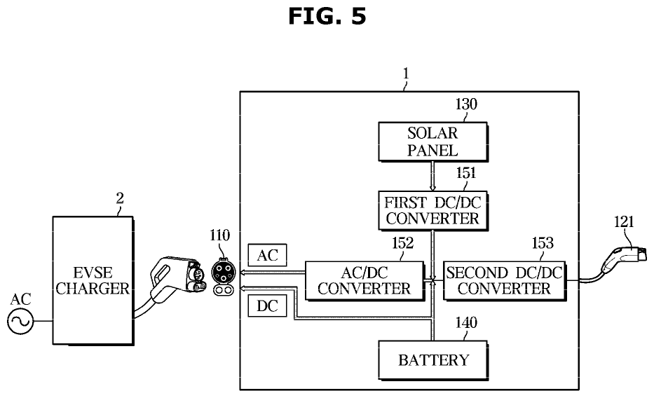

FIG. 5 is a diagram illustrating a case in which a charging device supplies power to a power system in some forms of the present disclosure.

Referring to FIG. 5, the controller 160 in some forms of the present disclosure may compare the power produced by the power system 2 with the power demanded through the power system 2 when a request for power from the power system 2 and the vehicle 3 has not been received. The controller 160 may control the power supply circuit 150 to supply power supplied from at least one of the battery 140 or the solar panel 130 to the power system 2 when the power produced by the power system 2 is less than the power demanded through the power system 2.

In other words, the charging device 1 allows the power system 2 to more efficiently respond to power demand by supplying power from the battery 140 or solar panel 130 to the power system 2 when the production power of the power system (2) is insufficient to meet the demand power. In this case, the charging device 1 may supply at least one of AC power or DC power to the power system 2 according to the type of the socket 110.

The controller 160 may control the power supply circuit 150 to allow the battery 140 to be charged by supplying the power supplied from the solar panel 130 to the power system 2 at the same time to the battery 140 when the battery 140 is discharged and can no longer supply power.

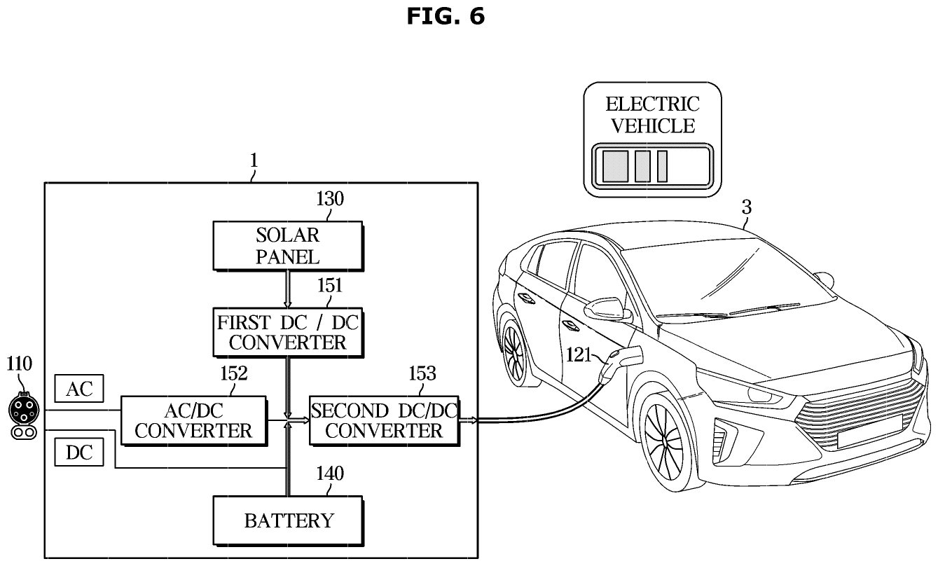

FIG. 6 is a diagram illustrating a case in which a charging device supplies power to a vehicle in some forms of the present disclosure.

Referring to FIG. 6, the controller 160 may control the power supply circuit 150 to supply power supplied from at least one of the battery 140 or the solar panel 130 to the vehicle 3 when receiving a request for power only from the vehicle 3.

At this time, the user can move the charging device 1 near the vehicle 3 in order to charge the vehicle 3. That is, since the charging device 1 may supply power to the battery 140 or the solar panel 130, the charging device 1 does not need to be connected to the power system 2 and the charging device 1 may move to a space where the vehicle 3 is parked to charge the vehicle 3.

Therefore, it is not necessary to provide a separate space (for example, an electric vehicle parking space in which a charging device is installed) for charging the vehicle 3.

The controller 160 may control the power supply circuit 150 to allow the battery 140 to be charged by supplying the power supplied from the solar panel 130 to the vehicle 3 at the same time to the battery 140 when the battery 140 is discharged and can no longer supply power.

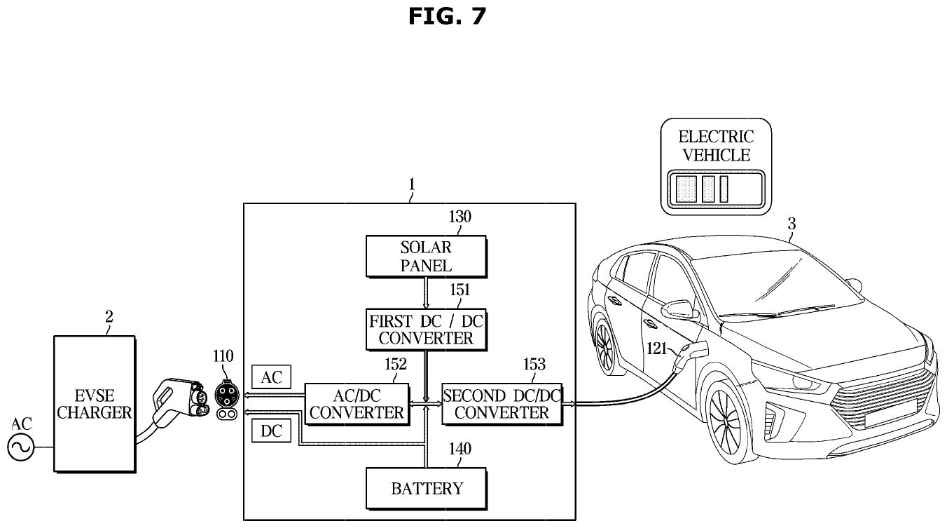

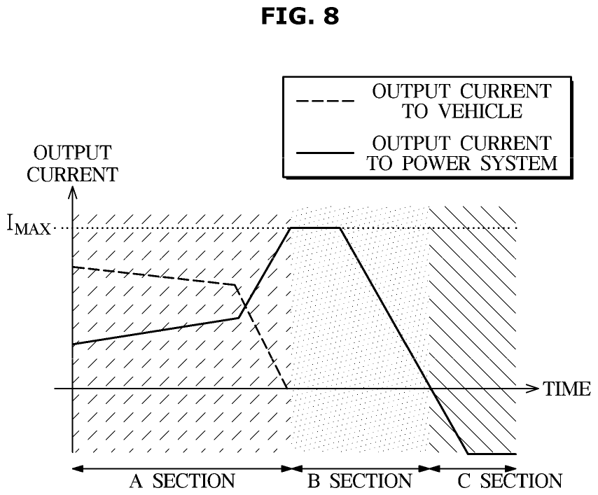

FIG. 7 is a diagram illustrating a case in which a charging device supplies power to both a power system and a vehicle in some forms of the present disclosure. FIG. 8 is a diagram illustrating an output current when a charging device supplies power to both a power system and a vehicle in some forms of the present disclosure.

Referring to FIG. 7, the controller 160, in some forms of the present disclosure, may control the power supply circuit 150 to supply power supplied from at least one of the battery 140 or the solar panel 130 to both the power system 2 and the vehicle 3 when a request for power is received from both the power system 2 and the vehicle 3.

In this case, the controller 160 may control the power supply circuit 150 as shown in FIG. 8, such that the sum of the current of the power supplied to the power system 2 and the current of the power supplied to the vehicle 3 is maintained at a predetermined value (e.g., the maximum output current Imax of the charging device 1) when power is supplied to both the power system 2 and the vehicle 3 (section A).

That is, the charging device 1 may adjust the amount of current supplied to the vehicle 3 and the power system 2 according to the charging situation. However, the charging device 1 controls the power supply circuit 150 such that the sum of the currents supplied to each of the vehicle 3 and the power system 2 is constant.

In addition, when the power supply to the vehicle 3 is completed and there is no current supplied to the vehicle 3 after controlling the power supply circuit 150 to supply power to both the power system 2 and the vehicle 3, the controller 160 may control the power supply circuit 150 to supply power to the power system 2 (B section in FIG. 8) or transfer power obtained from the power system 2 and the solar panel 130 to the battery 140 (C section in FIG. 8) based on a comparison between the power produced in the power system 2 and the power demanded through the power system 2.

That is, the controller 160 may control the power supply circuit 150 to supply power from the solar panel 130 or the battery 140 to the power system 2 (B section in FIG. 8) when the power generated by the power system 2 is less than the power demanded through the power system 2 after the power supply to the vehicle 3 is completed.

In addition, the controller 160 may control the power supply circuit 150 to receive power from the power system 2 and the solar panel 130 to charge the battery 140 (C section in FIG. 8) when the power generated by the power system 2 is greater than the power demanded through the power system 2 after the power supply to the vehicle 3 is completed.

In this case, the charging device 1 may supply at least one of AC power or DC power to the power system 2 according to the type of the socket 110.

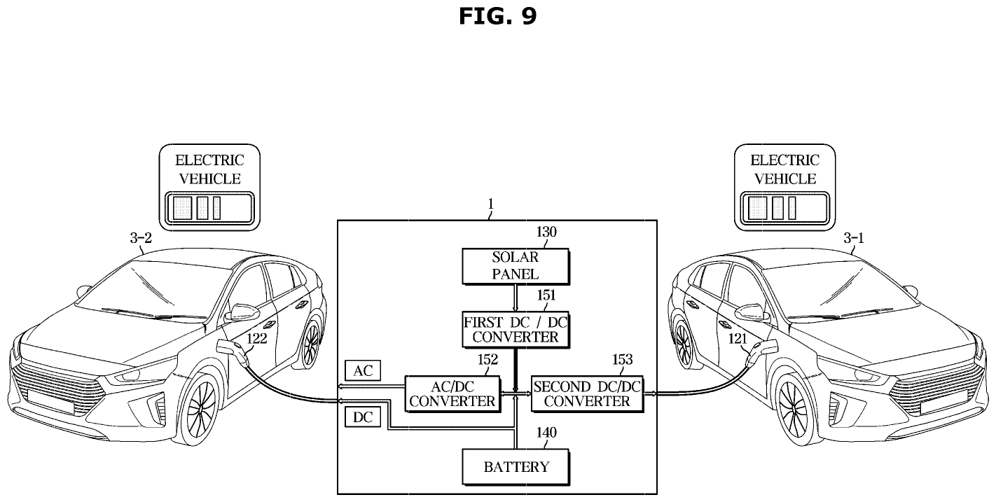

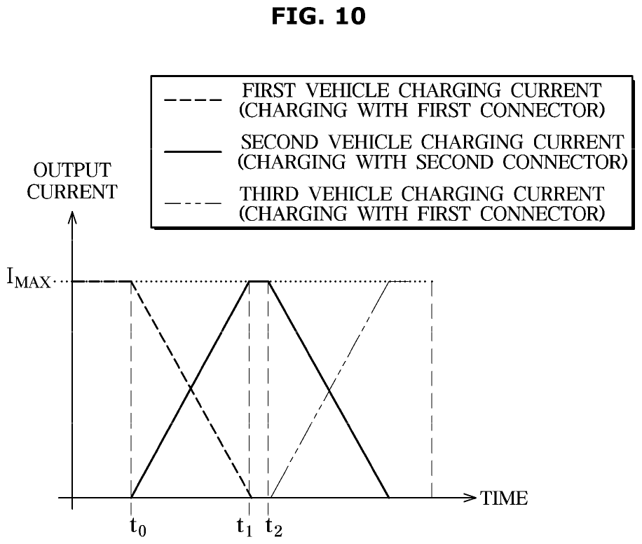

FIG. 9 is a diagram illustrating a case in which a charging device supplies power to a plurality of vehicles in some forms of the present disclosure. FIG. 10 is a diagram illustrating an output current when a charging device supplies power to a plurality of vehicles in some forms of the present disclosure.

Referring to FIG. 9, when receiving a request for power from vehicles 3-1, 3-2 connected to each of the first connector 121 and the second connector 122 and there is no request for power from the power system 2, the controller 160, in some forms of the present disclosure, may control the power supply circuit 150 to supply power supplied from at least one of the battery 140 or the solar panel 130 to vehicles 3-1, 3-2 connected to each of the first connector 121 and the second connector 122.

At this time, the controller 160 may supply a maximum output current (Imax in FIG. 10) to any one (eg: first vehicle 3-1 connected to first connector 121) of the vehicles 3-1, 3-2 connected to each of the first connector 121 and the second connector 122, reduce the current supplied to any one (eg: first vehicle 3-1) of the vehicle according to time after the end (t₀ of FIG. 10) of the charge by the maximum output current (Imax in FIG. 10), and control the power supply circuit 150 to supply an increasing current in correspondence with a decreasing amount of current supplied to the any one vehicle (eg: first vehicle 3-1) to the other one (eg: second vehicle (3-2) connected to second connector (122)) of the vehicles 3-1, 3-2 connected to each of the first connector 121 and the second connector 122.

That is, the sum of the output currents supplied to each of the first vehicle 3-1 and the second vehicle 3-2 may be the same as the maximum output current (Imax in FIG. 10). In addition, the time point at which charging by the maximum output current ends (t₀ in FIG. 10) may vary depending on the requested power amount of the first vehicle 3-1 and the remaining power amount of the first vehicle 3-1.

At this time, the end point of charging by the maximum output current may mean a time point to switch from a step in which the output current supplied to the first vehicle 3-1 to be charged preferentially is kept at the same value to a step at which the output voltage remains the same.

Specifically, the first vehicle 3-1, which is preferentially charged compared to the second vehicle 3-2, may be charged with the maximum output current of the charging device 1. Thereafter, the charging device 1 may supply power to the first vehicle 3-1 in such a manner that the output current gradually decreases while applying the same voltage. In this case, the output current supplied to the second vehicle 3-2 may increase as the output current supplied to the first vehicle 3-1 decreases.

In addition, the controller 160 may charge a third vehicle (not shown) by controlling the power supply circuit 150 such that the sum of the output currents supplied to each of the second vehicle 3-2 and the third vehicle (not shown) is equal to the maximum output current (Imax in FIG. 10) when the third vehicle (not shown) is connected through the first connector 121 while the second vehicle 3-2 is being charged after the charging of the first vehicle 3-1 is completed.

At this time, the first connector 121 may supply DC power boosted by the second DC/DC converter 153 to the vehicle, and the second connector 122 may supply DC power or AC power to the second vehicle 3-2. The DC power supplied from the second connector 122 to the second vehicle 3-2 is boosted by a motor-inverter (not shown) in the second vehicle 3-2 and supplied to the battery (not shown) in the second vehicle 3-2.

Through this, even if another vehicle is charging first, it is possible to charge simultaneously without having to wait until the end of charging, thereby reducing the charging waiting time and reducing the total time of charging several electric vehicles.

Hereinafter, a control method of the charging device 1 in some forms of the present disclosure will be described. The charging device 1 in some forms of the present disclosure may be applied to a control method of the charging device 1 described later. Therefore, the contents described above with reference to FIGS. 1 to 10 may be equally applicable to a control method of the charging device 1 in some forms of the present disclosure, even if there is no special mention.

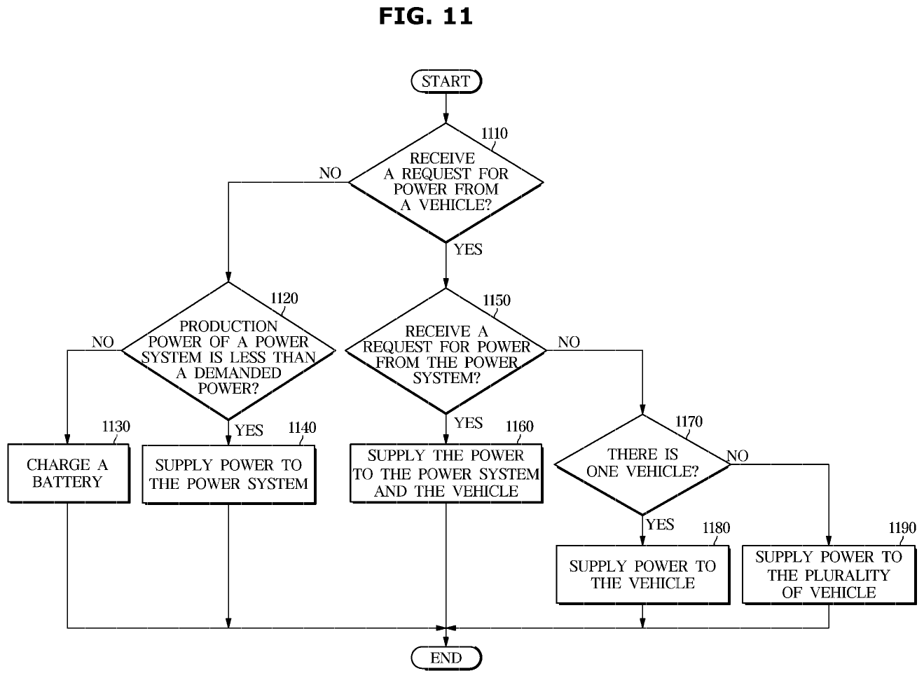

FIG. 11 is a flowchart illustrating a case of determining an operation mode of a control method of a charging device in some forms of the present disclosure.

Referring to FIG. 11, when the charging device 1 in some forms of the present disclosure does not receive a request for power from the vehicle 3 (NO in 1110), and the production power of the power system 2 is greater than or equal to the demanded power (YES in 1120), the charging device 1 may charge the battery 140.

That is, the controller 160 may compare the power produced by the power system 2 with the power demanded through the power system 2 when a request for power from the power system 2 and the vehicle 3 has not been received. The controller 160 may control the power supply circuit 150 to supply power obtained from at least one of the power system 2 or the solar panel 130 to the battery 140 when the power produced by the power system 2 is greater than the power demanded through the power system 2.

In some forms of the present disclosure, when the charging device 1 does not receive a request for power from the vehicle 3 (NO in 1110), and when the production power of the power system 2 is less than the demand power (YES in 1120), the charging device 1 may supply power to the power system 2 (1140).

That is, the controller 160 may compare the power produced by the power system 2 with the power demanded through the power system 2 when a request for power from the power system 2 and the vehicle 3 has not been received. The controller 160 may control the power supply circuit 150 to supply power supplied from at least one of the battery 140 or the solar panel 130 to the power system 2 when the power produced by the power system 2 is less than the power demanded through the power system 2.

In some forms of the present disclosure, when the charging device 1 receives a request for power from the vehicle 3 (YES in 1110) and receives a request for power from the power system (YES in 1150), the charging device 1 may supply the power to the power system 2 and the vehicle 3 (1160).

That is, the controller 160 may control the power supply circuit 150 to supply power supplied from at least one of the battery 140 or the solar panel 130 to both the power system 2 and the vehicle 3 when a request for power is received from both the power system 2 and the vehicle 3.

When the charging device 1 in some forms of the present disclosure receives a request for power from the vehicle 3 (YES in 1110), does not receive a request for power from the power system 2 (NO in 1150), When there is only one vehicle 3 (YES in 1170), the charging device 1 may supply power to the vehicle 3 (1180).

That is, the controller 160 may control the power supply circuit 150 to supply power supplied from at least one of the battery 140 or the solar panel 130 to the vehicle 3 when receiving a request for power only from the vehicle 3,

When the charging device 1 in some forms of the present disclosure receives a request for power from the vehicle 3 (YES in 1110), does not receive a request for power from the power system 2 (NO in 1150), when the number of vehicles 3 is not one (NO in 1170), the charging device 1 may supply power to the plurality of vehicles 3 (1190).

For example, when receiving a request for power from vehicles 3-1, 3-2 connected to each of the first connector 121 and the second connector 122 and there is no request for power from the power system 2, the controller 160 may control the power supply circuit 150 to supply power supplied from at least one of the battery 140 or the solar panel 130 to vehicles 3-1, 3-2 connected to each of the first connector 121 and the second connector 122.

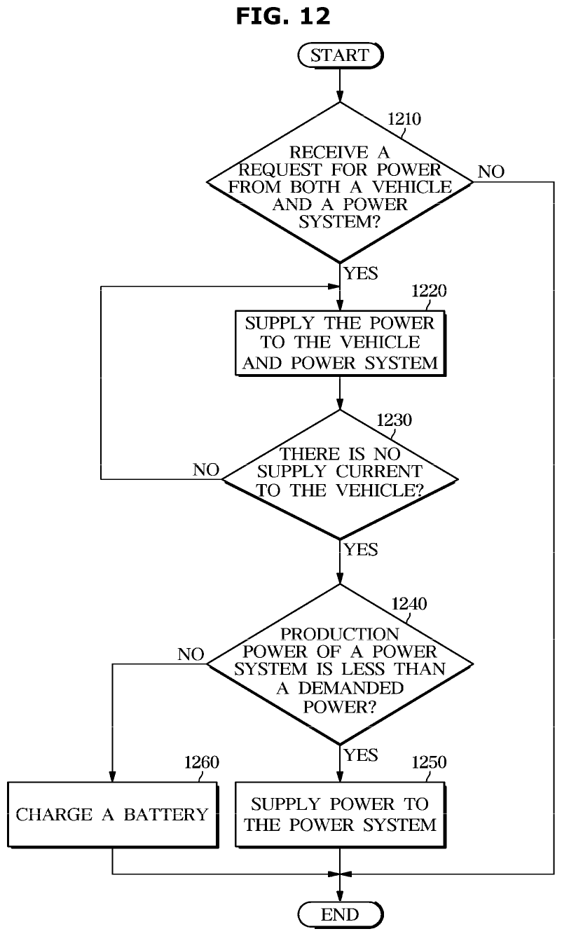

FIG. 12 is a flowchart illustrating a case where a request for power is received from both a power system and a vehicle in a control method of a charging device in some forms of the present disclosure.

Referring to FIG. 12, when the charging device 1 receives a request for power from both the vehicle 3 and the power system 2 (YES in 1210), the charging device 1 may supply the power to the vehicle 3 and power system 2 (1220).

That is, the controller 160 may control the power supply circuit 150 to supply power supplied from at least one of the battery 140 or the solar panel 130 to both the power system 2 and the vehicle 3 when a request for power is received from both the power system 2 and the vehicle 3.

Thereafter, the charging device 1 may supply power to the power system 2 (1250) when there is no supply current to the vehicle 3 (YES in 1230), and the production power of the power system 2 is less than the demanded power (YES in 1240).

In addition, the charging device 1 may charge the battery 140 (1260) when there is no supply current to the vehicle (YES in 1230), and the production power of the power system 2 is equal to or greater than the demanded power (NO in 1240).

That is, when the power supply to the vehicle 3 is completed and there is no current supplied to the vehicle 3 after controlling the power supply circuit 150 to supply power to both the power system 2 and the vehicle 3, the controller 160 may control the power supply circuit 150 to supply power to the power system 2 or transfer power obtained from the power system 2 and the solar panel 130 to the battery 140 based on a comparison between the power produced in the power system 2 and the power demanded through the power system 2.

That is, the controller 160 may control the power supply circuit 150 to supply power from the solar panel 130 or the battery 140 to the power system 2 when the power generated by the power system 2 is less than the power demanded through the power system 2 after the power supply to the vehicle 3 is completed.

In addition, the controller 160 may control the power supply circuit 150 to receive power from the power system 2 and the solar panel 130 to charge the battery 140 when the power generated by the power system 2 is greater than the power demanded through the power system 2 after the power supply to the vehicle 3 is completed.

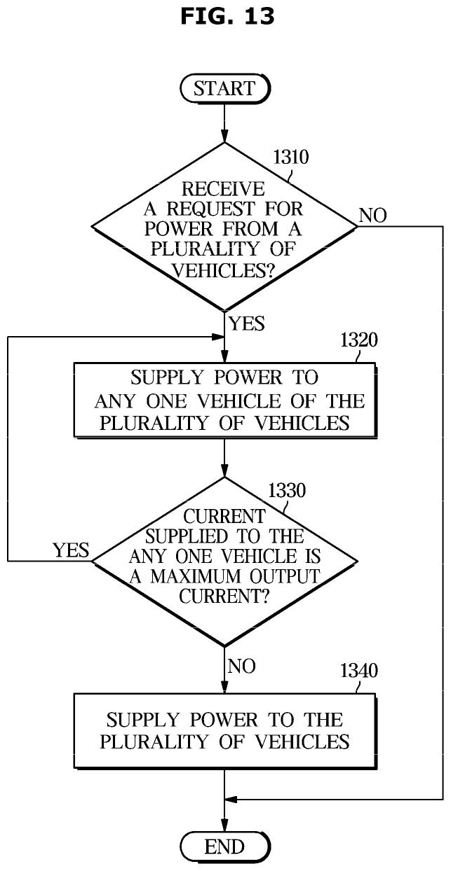

FIG. 13 is a flowchart illustrating a case where a request for power is received from a plurality of vehicles in a control method of a charging device in some forms of the present disclosure.

Referring to FIG. 13, when the charging device 1 receives a request for power from a plurality of vehicles 3 (YES in 1310), the charging device 1 may supply power to any one vehicle 3 of the plurality of vehicles 3 (1320).

Thereafter, when the supply current to the vehicle 3 is not the maximum output current (NO in 1330), the charging device 1 may supply power to the plurality of vehicles 3 (1340).

That is, when receiving a request for power from vehicles 3-1, 3-2 connected to each of the first connector 121 and the second connector 122 and there is no request for power from the power system 2, the controller 160 may control the power supply circuit 150 to supply power supplied from at least one of the battery 140 or the solar panel 130 to vehicles 3-1, 3-2 connected to each of the first connector 121 and the second connector 122.

At this time, the controller 160 may supply a maximum output current (Imax) to any one (eg: first vehicle 3-1 connected to first connector 121) of the vehicles 3-1, 3-2 connected to each of the first connector 121 and the second connector 122, reduce the current supplied to any one (eg: first vehicle 3-1) of the vehicle according to time after the end of the charge by the maximum output current (Imax), and control the power supply circuit 150 to supply an increasing current in correspondence with a decreasing amount of current supplied to the any one vehicle (eg: first vehicle 3-1) to the other one (eg: second vehicle (3-2) connected to second connector (122)) of the vehicles 3-1, 3-2 connected to each of the first connector 121 and the second connector 122.

According to a charging device and a control method thereof according to an aspect, it is possible to move to a place where a vehicle requesting charging is located, thereby providing convenience of charging. In addition, by providing power to the power system in addition to the vehicle, it is possible to effectively cope with the increase in the power demand according to the increase of the electric vehicle.

Meanwhile, some forms of the present disclosure may be implemented in the form of a recording medium storing instructions that are executable by a computer. The instructions may be stored in the form of a program code, and when executed by a processor, the instructions may generate a program module to perform operations of some forms of the present disclosure. The recording medium may be implemented as a computer-readable recording medium.

The computer-readable recording medium may include all kinds of recording media storing commands that can be interpreted by a computer. For example, the computer-readable recording medium may be ROM, RAM, a magnetic tape, a magnetic disc, flash memory, an optical data storage device, etc.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A charging device, comprising:
a battery;
a solar panel;
a socket electrically connected to a power system;
a first connector electrically connected to a vehicle;
a transceiver configured to communicate with the power system and the vehicle;
a power supply circuit electrically connected to the battery, the solar panel, the socket and the first connector; and
a controller configured to control the power supply circuit to supply power that is supplied from at least one of the battery or the solar panel to at least one of the power system or the vehicle when a request for power is received from the power system and the vehicle.

2. The charging device of claim 1, wherein the controller is configured to:
control the power supply circuit to supply power that is supplied from at least one of the battery or the solar panel to both the power system and the vehicle when the request for power is received from the power system and the vehicle.

3. The charging device of claim 2, wherein the controller is configured to:
control the power supply circuit to maintain a sum of a current of power supplied to the power system and a current of power supplied to the vehicle at a predetermined value.

4. The charging device of claim 2, wherein the controller is configured to:
control the power supply circuit to supply power to the power system or transfer power obtained from the power system and the solar panel to the battery based on a comparison between the power produced in the power system and the power demanded through the power system when the power supply to the vehicle is completed and no current is supplied to the vehicle after controlling the power supply circuit to supply power to both the power system and the vehicle.

5. The charging device of claim 1, wherein the power supply circuit comprises:
an alternating current (AC) to direct current (DC) converter electrically connected to the socket;
a first DC to DC converter electrically connected to the solar panel; and
a second DC to DC converter electrically connected to the first connector.

6. The charging device of claim 5, wherein the device further comprises:
a second connector electrically connected to the AC to DC converter and electrically connected to the vehicle,
wherein the controller is configured to control the power supply circuit to supply power supplied from at least one of the battery or the solar panel to vehicles connected to the first connector and the second connector when a request for power from the vehicles connected to the first connector and the second connector is received and no request for power is received from the power system.

7. The charging device of claim 6, wherein the controller is configured to:
supply a maximum output current to any one of the vehicles connected to the first connector and the second connector;
reduce the current supplied to any one of the vehicles corresponding to a time after the charge is completed by the maximum output current; and
control the power supply circuit to supply an increasing current corresponding to a decreasing amount of current supplied to any one of the vehicles connected to the first connector and the second connector.

8. The charging device of claim 6, wherein:
the first connector is configured to supply a DC power boosted by the second DC to DC converter to the vehicle,
the second connector is configured to supply DC power or AC power to the vehicle, and
the DC power supplied to the vehicle from the second connector is boosted by a motor-inverter in the vehicle and is supplied to the battery in the vehicle.

9. The charging device of claim 1, wherein the controller is configured to:
compare the power produced by the power system with the power demanded through the power system when a request for power from the power system and the vehicle is not received;
control the power supply circuit to supply power obtained from at least one of the power system or the solar panel to the battery when the power produced by the power system is greater than the power demanded through the power system; and
control the power supply circuit to supply power supplied from at least one of the battery or the solar panel to the power system when the power produced by the power system is less than the power demanded through the power system.

10. The charging device of claim 1, wherein the controller is configured to:
control the power supply circuit to supply power supplied from at least one of the battery or the solar panel to the vehicle when a request for power is received only from the vehicle.

11. A control method of charging device comprising:
controlling a power supply circuit to supply power supplied from at least one of a battery or a solar panel to at least one of a power system or a vehicle when a request for power from the power system and the vehicle is received.

12. The control method of claim 11, wherein controlling the power supply circuit comprises:
controlling the power supply circuit to supply power supplied from at least one of the battery or the solar panel to both the power system and the vehicle when the request for power is received from the power system and the vehicle.

13. The control method of claim 12, wherein controlling the power supply circuit comprises:
controlling the power supply circuit to maintain a sum of a current of power supplied to the power system and a current of power supplied to the vehicle at a predetermined value.

14. The control method of claim 12, wherein controlling the power supply circuit comprises:
when the power supply to the vehicle is completed and no current is supplied to the vehicle after controlling the power supply circuit to supply power to both the power system and the vehicle, controlling the power supply circuit to supply power to the power system or transfer power obtained from the power system and the solar panel to the battery based on a comparison between the power produced in the power system and the power demanded through the power system.

15. The control method of claim 11, wherein the power supply circuit comprises:
an alternating current (AC) to direct current (DC) converter electrically connected to a socket;
a first DC to DC converter electrically connected to the solar panel; and
a second DC to DC converter electrically connected to the first connector.

16. The control method of claim 15, wherein controlling the power supply circuit comprises:
when a request for power from vehicles connected to the first connector and the second connector is received and no request for power from the power system is received, controlling the power supply circuit to supply power supplied from at least one of the battery or the solar panel to vehicles connected to the first connector and the second connector.

17. The control method of claim 16, wherein controlling the power supply circuit comprises:
supplying a maximum output current to any one of the vehicles connected to the first connector and the second connector;
reducing the current supplied to the any one of the vehicles corresponding to a time after the charge is completed by the maximum output current; and
controlling the power supply circuit to supply an increasing current corresponding to a decreasing amount of current supplied to any one of the vehicles connected to the first connector and the second connector.

18. The control method of claim 16, wherein:
supplying, by the first connector, a DC power boosted by the second DC to DC converter to the vehicle;
supplying, by the second connector, DC power or AC power to the vehicle;
boosting, by a motor inverter, the DC power supplied to the vehicle from the second connector; and
supplying, the DC power supplied to the vehicle from the second connector to the battery in the vehicle.

19. The control method of claim 11, wherein controlling the power supply circuit comprises:
comparing the power produced by the power system with the power demanded through the power system when a request for power from the power system and the vehicle is not received;
controlling the power supply circuit to supply power obtained from at least one of the power system or the solar panel to the battery when the power produced by the power system is greater than the power demanded through the power system; and
controlling the power supply circuit to supply power supplied from at least one of the battery or the solar panel to the power system when the power produced by the power system is less than the power demanded through the power system.

20. The control method of claim 11, wherein controlling the power supply circuit comprises:
controlling the power supply circuit to supply power supplied from at least one of the battery or the solar panel to the vehicle when a request for power is received only from the vehicle.
